(19) United States
(12) Patent Application Publication
(10) Pub. No.: US 2014/0114778 A1
(43) Pub. Date: Apr. 24, 2014

(54) TECHNIQUES FOR DRIVE THRU MOBILE ORDERING

(71) Applicants: Joel Aaron Miller, Atlanta, GA (US); Michael Cain Finley, Roswell, GA (US)

(72) Inventors: Joel Aaron Miller, Atlanta, GA (US); Michael Cain Finley, Roswell, GA (US)

(73) Assignee: NCR Corporation, Law Dept., Duluth, GA (US)

(21) Appl. No.: 13/659,424

(22) Filed: Oct. 24, 2012

(51) Int. Cl. G06Q 20/20

(52) U.S. Cl. 705/16

(57) ABSTRACT

Techniques for drive-thru mobile ordering are provided. When a consumer's mobile device is detected within a drive-thru queue or within a configurable distance of a Point-Of-Sale (POS) terminal for drive-thru ordering, an interactive ordering interface is presented on the mobile device of the consumer. The consumer places his/her order via that interface and may optionally make payment for the order. The interface interacts with a POS agent of an establishment where the consumer is making the order to take the order and ensure fulfillment of that order.

### BACKGROUND

Consumers are increasingly using kiosks to conduct business with enterprises. The kiosks come in a variety of sizes and are used for a variety of purposes. Some kiosks are drive through, such as fast food establishments, pharmacies, banks, and the like. Other kiosks are stationary located in gas stations, airlines, grocery stores, department stores, and the like.

In addition, what is considered a kiosk is evolving with today's technology. For example, digital signs now provide advertisements and mechanisms for users to interact with the displays to perform transactions.

One kiosk technology area that has largely not undergone any significant automation over the years is that which is associated with drive-thru kiosks. For the most part, the only improvement that drive-thru kiosks have undergone is the confirmation screen that most drive-thru establishments now have so the consumer can confirm the order was received properly via a digital display. The other automation that drive-thru establishments have achieved is primarily not even noticeable to the consumer, such as wireless headsets for the attendant taking the orders of the consumers.

In fact, today's interaction at the drive-thru line is awkward and in many instances inconvenient for both the consumer and the employees of the establishment providing the drive-thru ordering system. For example, it is often difficult to hear the person taking one's order; it may also be hard for the attendant to hear the consumer placing the order. In yet another case, it can be cold, snowy, winding, or even raining when a consumer is attempting to place an order and the last thing the consumer wants to do is roll down the window. Furthermore, at establishments that lack confirmation screens, the order can be messed up (miss taken or incomplete).

### SUMMARY

In various embodiments, techniques for drive-thru mobile ordering are presented. According to an embodiment, a method for drive-thru mobile ordering is provided.

Specifically, a Point-Of-Sale (POS) terminal is detected by a mobile device. Next, a POS interface for placing an order is initiated on the mobile device. Finally, the order is defined in the POS interface by a consumer, and the order wirelessly communicated from the mobile device to a POS agent for a POS system that includes the POS terminal.

### BRIEF DESCRIPTION OF THE DRAWINGS

FIG. 1 is a diagram of a method for drive-thru mobile ordering, according to an example embodiment.

FIG. 2 is a diagram of another method for drive-thru mobile ordering, according to an example embodiment.

FIG. 3 is a diagram of a drive-thru mobile ordering system, according to an example embodiment.

### DETAILED DESCRIPTION

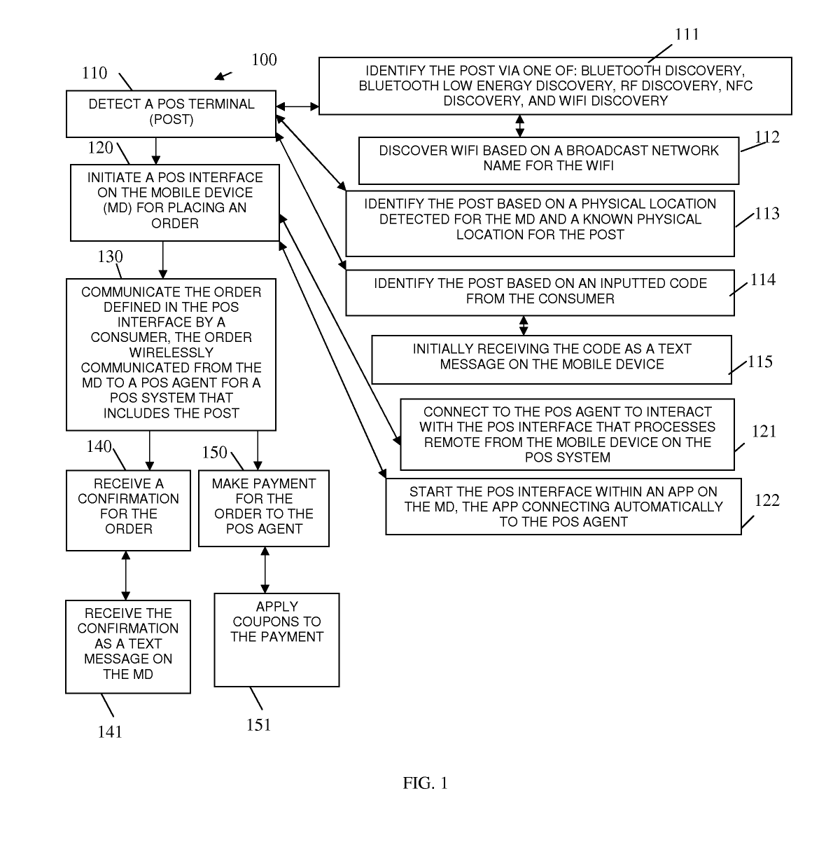

FIG. 1 is a diagram of a method 100 for drive-thru mobile ordering, according to an example embodiment. The method 100 (hereinafter “mobile-device ordering agent”) is implemented as instructions programmed and residing on a non-transitory computer-readable (processor-readable) storage medium and executed by one or more processors or a mobile device (e.g., smart phone, tablet, etc.). The processors are specifically configured and programmed to process the mobile-device ordering agent. The mobile-device ordering agent operates over a network. The network is wireless.

The mobile device can also include devices that are built into vehicles or any other composite devices, such as a car having a built in data or cellular connection, goggles, apparel, headsets, and the like.

At 110, the mobile-device ordering agent detects a POS terminal for a drive-thru establishment. In an embodiment, the POS terminal can be a traditional drive-thru having a two-way microphone equipped with devices or mechanisms for it to be discovered. The devices or mechanisms can be on or near the POS terminal or at the drive-thru establishment. In some cases, if a location-based detecting mechanism is used; such mechanism does not even have to be on site of the drive-thru establishment. The detection can occur in a variety of manners.

For example, at 111, the mobile-device ordering agent identifies the POS terminal via one of: a Bluetooth discovery mechanism, a Bluetooth Low Energy (BLE) discovery mechanism, a Radio Frequency (RF) discovery mechanism, a Near Field Communication (NFC) discovery mechanism, and a WiFi discovery mechanism.

According to an embodiment, at 112, the mobile-device ordering agent discovers WiFi based on a broadcast network name for the WiFi.

In another case, at 113, the mobile-device ordering agent identifies the POS terminal based on a physical location detected for the mobile device and a known physical location for the POS terminal. In other words, the mobile device may be registered with a POS system of the drive-thru establishment that includes the POS terminal and the mobile-device ordering agent publishes its physical location with the POS system and the POS system compares this to a known physical location of the drive-thru establishment or the POS terminal to send a message to the mobile-device ordering agent that it is at or near the POS terminal.

In yet another situation, at 114, the mobile-device ordering agent identifies the POS terminal based on an inputted code from the consumer. Here, a code can either be published, displayed, scanned (as a Quick Response (QR) code or barcode), or sent directly to the mobile device that once provided detects or permits connection to a POS terminal of the drive-thru establishment.

Continuing with the embodiment of 114 and at 115, the mobile-device ordering agent initially receives the code as a text message on the mobile device.

At 120, the mobile-device ordering agent initiates a POS interface on the mobile device for placing an order. Where the POS interface is processed can vary.

For example, at 121, the mobile-device ordering agent connects to the POS agent (discussed below at 130) to interact with the POS interface that is processing remote from the mobile device on the POS system.

In an alternative case, at 122, the mobile-device ordering agent starts the POS interface within an app on the mobile device. The app on the mobile device connects automatically to the POS agent.

At 130, the mobile-device ordering agent communicates the order defined in the POS interface by a consumer of the mobile device. The order is wirelessly communicated from the mobile device to the POS agent for a POS system that includes the POS terminal. Essentially, traditional drive-thru ordering occurs via the mobile device.

It may also be that the mobile-device uses a cellular connection to connect to the POS system or POS agent that is hosted in a cloud environment or via a server remote from the drive-thru establishment entirely. So, connection can be cellular, via a call or via a data connection from the phone to the POS system.

According to an embodiment, at 140, the mobile-device ordering agent receives a confirmation for the order.

Continuing with the embodiment of 140 and at 141, the mobile-device ordering agent receives the confirmation as a text message on the mobile device.

In an embodiment, at 150, the mobile-device ordering agent makes payment for the order to the POS agent.

Continuing with the embodiment of 150 and at 151, the mobile-device ordering agent applies coupons or gift certificates or loyalty rewards to the payment.

In an embodiment, the mobile-device ordering agent provides a direct audio connection on the mobile device to an attendant in the drive-thru establishment that is processing the order. Here, the interface can be audible but occurring via the mobile device of the consumer and not via the POS terminal.

In another case, the mobile-device ordering agent can provide ordering via selections on the interface being processed via the mobile device and augment the ordering process with a direct audible connection to the attendant.

In still another situation, the customer can be provided a number on the mobile device or a link to activate that calls the attendant to confirm an order once placed, when the order was not using audible communications. This can also be used when an order was confirmed but incorrect from what the customer ordered.

It is now apparent that this above-described ordering technique provides a variety of benefits, such as: no specialized hardware needed by consumers they can use their own devices (phones, tablets, etc.); no specialized hardware needed at the drive-thru establishment (such as restaurant) other than existing POS terminals; customer does not have to roll down window except to receive food; customer does not have to make payments manually with the attendant so fraud is decreased; customer does not have to use unreliable restaurant audio equipment to hear or speak with an attendant; and/or customer can use calls to attendant to correct order issues or confirm orders.

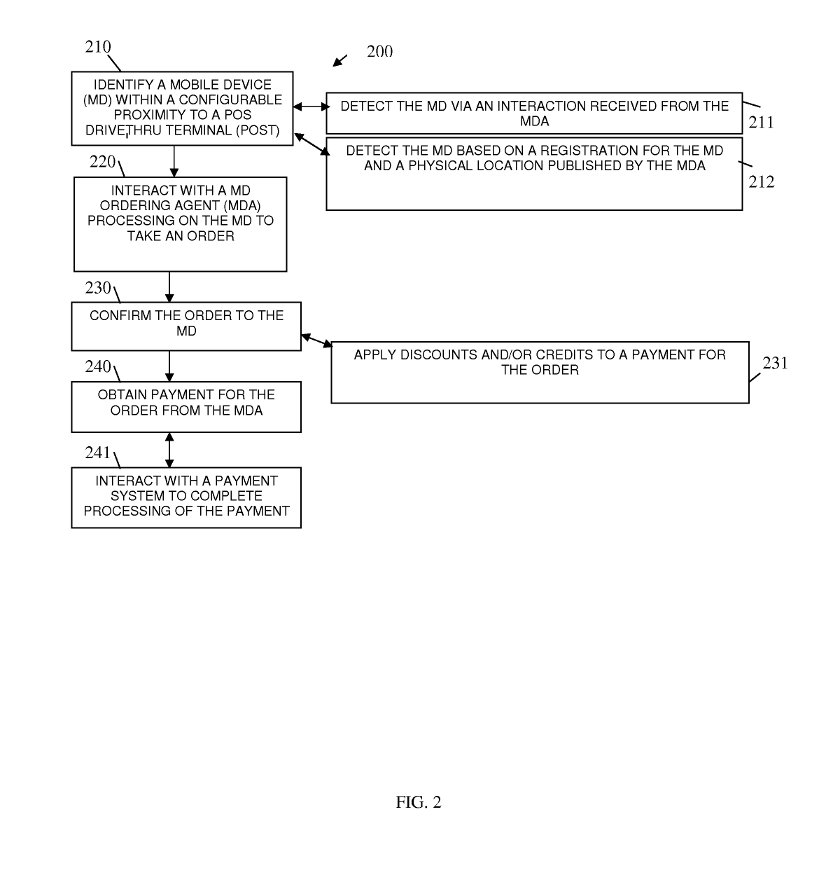

FIG. 2 is a diagram of another method 200 for drive-thru mobile ordering, according to an example embodiment. The method 200 (hereinafter “Point-Of-Sale (POS) ordering agent”) is implemented as instruction and programmed within a non-transitory computer-readable (processor-readable) storage medium that executes on one or more processors of a Point-of-Sale (POS) devices or set of devices (system), such as: a cashier-manned device, set of devices, or any computing device for which a customer order can be taken; the processors of these devices are specifically configured to execute the POS ordering agent. The POS ordering agent is also operational over a network; the network is wired, wireless, or a combination of wired and wireless.

The POS ordering agent interacts with the mobile device ordering agent described above with reference to the FIG. 1 to provide novel techniques for taking and processing drive-thru orders of a customer. The POS ordering agent may also interact with other systems of an enterprise, such as loyalty systems, payment systems, and the like.

At 210, the POS ordering agent identifies a mobile device within a configured proximity distance to a POS drive-thru terminal. Again, this can be achieved based on actions of the mobile-device ordering agent on the mobile device of a consumer (such as via a scan of a QR code, and the like) or can occur via actions of the POS ordering agent.

So, at 211, the POS ordering agent detects the mobile device via an interaction received from the mobile-device ordering agent (such as the mobile-device ordering agent discussed above with reference to the FIG. 1). This can be a connection request received via Bluetooth, WiFi, text messaging session, RF, NFC, QR scan over network, and the like.

In another case, at 212, the POS ordering agent detects the mobile device based on a prior registration for the mobile device with the POS ordering agent and a physical location published by the mobile-device ordering agent.

At 220, the POS ordering agent interacts with the mobile-device ordering agent processing on the mobile device to take an order.

At 230, the POS ordering agent confirms the order to mobile device.

According to an embodiment, at 231, the POS ordering agent applies discounts and/or other credits to a payment for the order.

According to an embodiment, at 240, the POS ordering agent obtains payment for the order from the mobile-device ordering agent.

Continuing with the embodiment of 240 and at 241, the POS ordering agent interacts with a third-party payment system to complete processing for the payment.

In an embodiment, the POS ordering agent processes in a remote cloud-based or remote server-based environment that is remote from the drive-thru establishment. That is, the POS terminals within the drive-thru establishment can be thin clients with the bulk of the processing occurring in the cloud via the POS ordering agent. In other cases, pieces of a POS system can exists on site at the drive-thru establishment with other pieces, such as the POS ordering agent being cloud or remote-server based.

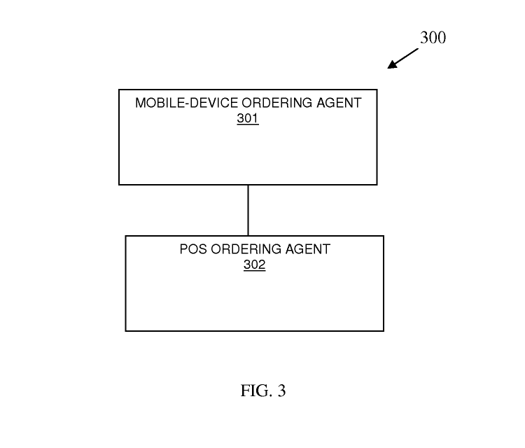

FIG. 3 is a diagram of a drive-thru mobile ordering system 300, according to an example embodiment. The components of the drive-thru mobile ordering system 300 are implemented as executable instructions and programmed within a non-transitory computer-readable (processor-readable) storage medium that execute on one or more processors of an enterprise server system and one or more processors of a device where custom drive-thru orders handled as discussed above with reference to the FIGS. 1 and 2; the processors of these devices are specifically configured to execute the components of the drive-thru mobile ordering system 300. The drive-thru mobile ordering system 300 is also operational over a network; the network is wired, wireless, or a combination of wired and wireless.

The drive-thru mobile ordering system 300 includes a mobile-device ordering agent 301 and a POS ordering agent 302. Each of these components and the interactions of each component are now discussed in turn.

The drive-thru mobile ordering system 300 includes one or more processors of an enterprise (retail-based) server and/or POS system, the processors having memory configured to distribute the mobile-device ordering agent 301. A mobile device of a consumer includes memory for receiving, installing, and executing on the mobile device the mobile-device ordering agent 301. Example processing associated with the mobile-device ordering agent 301 was presented in detail above with reference to the FIG. 1.

The mobile-device ordering agent 301 is configured to automatically detect a drive-thru POS terminal and to establish automatic communications with the POS ordering agent 302.

In an embodiment, the mobile-device ordering agent 301 is configured to complete a payment for the customer order with the POS ordering agent 302.

The offer deployment system 300 also includes one or more processors of a POS system, the processors having memory configured with the POS ordering agent 302, which is implemented, programmed, and resides within a non-transitory computer-readable storage medium and executes on the one or more processors. Example processing associated with the POS ordering agent 302 was presented in detail above with reference to the FIG. 2.

The POS ordering agent 302 is configured to interact with the mobile-device ordering agent 301 to complete a customer order that incurs entirely (except for the delivery of the goods (food, etc.)) from the mobile device and the POS system.

In an embodiment, the server and the POS terminal are part of the POS system. In another case, the mobile-device ordering agent 301 is acquired from a server (such as an app store) that is independent and separate entirely from the POS system. In still another situation, the server is part of the POS system and thus can deliver the mobile-device ordering agent 301 from the POS system when the customer is in the vicinity of the drive-thru establishment and the POS terminal.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
detecting, at a mobile device, a Point-Of-Sale (POS) terminal that is a traditional drive-thru POS terminal having a two-way microphone and equipped with a mechanism for automated discovery by the mobile device;
initiating, on the mobile device, a POS interface for placing an order; and
communicating, from the mobile device, the order defined in the POS interface by a consumer, the order wirelessly communicated from the mobile device to a POS agent for a POS system that includes the POS terminal.

2. The method of claim 1, wherein detecting further includes identifying the POS terminal via one of: Bluetooth discovery, Bluetooth Low Energy discovery, Radio Frequency discovery, Near Field Communication discovery, and WiFi discovery.

3. The method of claim 2, wherein identifying further includes discovering WiFi based on a broadcast network name for the WiFi.

4. The method of claim 1, wherein detecting further includes identifying the POS terminal based on an inputted code from the consumer.

5. The method of claim 4, wherein identifying further includes initially receiving the code on the mobile device as a text message.

6. The method of claim 1, wherein initiating further includes connecting to the POS agent to interact with the POS interface, and wherein the POS interface processes remote from the mobile device on the POS system.

7. The method of claim 1, wherein initiating further includes starting the POS interface within an application on the mobile device, the app connecting automatically to the POS agent.

8. The method of claim 1 further comprising, receiving, on the mobile device, a confirmation for the order.

9. The method of claim 8, wherein receiving further includes obtaining the confirmation as a text message on the mobile device.

10. The method of claim 1 further comprising, making payment, from the mobile device, to the POS agent for the order.

11. The method of claim 10, wherein making payment further includes applying coupons to the payment.

12. A method, comprising:
identifying, on a POS device, a mobile device within a configurable proximity to a POS drive-thru terminal, the POS device remotely located in a cloud from the POS drive-thru terminal that is a traditional drive-thru having a two-way microphone and supporting traditional drive-thru ordering;
interacting, via the POS device, with a mobile-device ordering agent processing on the mobile device to take an order; and
confirming, via the POS device, the order to the mobile device.

13. The method of claim 12 further comprising, obtaining, via the POS device, payment for the order from the mobile-device ordering agent.

14. The method of claim 13 further comprising, interacting, via the POS device with a payment system to complete processing of the payment.

15. The method of claim 12 further comprising, applying, via the POS device, discounts and/or credits to a payment for the order.

16. The method of claim 12, wherein identifying further includes detecting the mobile device via an interaction received from the mobile-device ordering agent.

17. The method of claim 12, wherein identifying further includes detecting the mobile device based on a registration for the mobile device and a physical location published by the mobile-device ordering agent.

18. A system comprising:
a server configured to distribute a mobile-device ordering agent to memory of a mobile device, the mobile-ordering agent processing on the mobile device; and
a Point-Of-Sale (POS) system having memory configured with a POS ordering agent that executes on one or more processors of the POS ordering agent;
wherein the mobile-device ordering agent is configured to automatically detect a drive-thru POS terminal and to establish automatic communications with the POS ordering agent, the POS ordering agent configured to interact with the mobile-device ordering agent to complete a customer order and the POS system remotely located from the POS terminal in a cloud, the POS terminal is a traditional drive-thru having a two-way microphone and supporting traditional drive-thru ordering.

19. The system of claim 18, wherein the mobile-device ordering agent is configured to complete a payment for the customer order with the POS ordering agent.

20. The system of claim 18, wherein the server and the drive-thru POS terminal are part of the POS system.
